(19) United States
(12) Patent Application Publication
(10) Pub. No.: US 2008/0066525 A1
(43) Pub. Date: Mar. 20, 2008

(54) Container Inspection Method and System

(75) Inventors: Hajime Kojima, Gifu (JP); Yoshitaro Horiba, Gifu (JP); Osamu Yoshida, Gifu (JP); Chizuka Kai, Tokyo (JP); Tadayoshi Teramoto, Osaka-shi (JP)

Correspondence Address: EDWARDS ANGELL PALMER & DODGE LLP, P.O. BOX 55874, BOSTON, MA, 02205, US

(73) Assignees: KABUSHIKI KAISHA N-TECH, Yoro-gun Gifu (JP); KABUSHIKI KAISHA YAKULT HONSHA, Tokyo (JP); TOHOSHOJI KABUSHIKI KAISHA, Osaka-shi, (JP)

(21) Appl. No.: 11/587,952

(22) PCT Filed: Apr. 25, 2005
(86) PCT No.: PCT/JP05/07809

§ 371 Date: Sep. 12, 2007

(30) Foreign Application Priority Data
Jun. 24, 2004 (JP) 2004-186122

(51) Int. Cl. G01M 3/04

(52) U.S. Cl. 73/45.4

(57) ABSTRACT

[PROBLEM] To provide a novel inspection method and system of a container enabling inspection of excess entrainment of air inside a flexible container and inspection of seal defects of a flexible container to be performed by a single technique simultaneously, enabling a full run of flexible containers to be continuously inspected on the production line, and giving a high inspection precision.

[MEANS FOR SOLUTION] Inspecting for seal defects of a container and excess entrainment of air in a container in an inspected object comprised of a flexible container in which a liquid is filled, during which placing the inspected object in an air-tight container, sucking out the air in the air-tight container to reduce the pressure sufficient to make container outer walls of the inspected object expand, measuring an expansion dimension of the container outer walls, and comparing it with a preset threshold value to judge the quality of the inspected object.

### TECHNICAL FIELD

The present invention relates to an inspection method and system for a paper pack containing a liquid, a blood transfusion bag, or other flexible container.

### BACKGROUND ART

For example, when filling a paper pack with a beverage, air is sometimes entrained. If excessive air is entrained in the container, insufficient filling, spoilage of the filled beverage, and other trouble with the product occur.

As a means for inspecting for excess entrainment of air in this type of flexible container, it is known to place the inspected object in which liquid is filled in an air-tight space, reduce the pressure, detect the presence of any expansion of the flexible container outer walls, and, when the outer walls expand (change), judge that excess air is entrained, while when no change occurs, judge that the product is good (see Patent Document 1).

On the other hand, another problem with this type of flexible container is the problem of liquid leakage. Liquid leakage is mainly due to a poor heat seal of the container, pinholes in the container material, and other seal defects. This causes spoilage of the filled beverage, so is considered a serious defect in quality control.

As means for inspecting for this liquid leakage, it is known to press the inspected object in which a liquid is filled and inspect for any leakage of the liquid. According to this, liquid leaked from the inspected object is inspected for by running a current between electrodes of an inspection unit (see Patent Document 2).

As explained above, in the past, the inspection of excess air entrainment in a flexible container and the inspect of liquid leakage were conducted by separate, different techniques. This was troublesome and inefficient. Further, in the means for inspecting for liquid leakage, the leaked liquid contaminated the inspection system and made the inspection by conduction no longer accurate, so the inspection system had to be cleaned each time and therefore continuous inspection of the entire run of flexible containers was not possible.

Patent Document 1: Japanese Patent Publication (B2) No. H8-5471

Patent Document 2: Specification of Japanese Patent No. 2694483

### Disclosure of the Invention

Problem to be Solved by the Invention

The present invention was proposed in consideration of this situation and has as its object the provision of an inspection method and system enabling simultaneous inspection of excess entrainment of air in a flexible container and inspection of seal defects of a flexible container by a single technique. Further, the present invention has as its object to provide a novel inspection method and system enabling an entire run of flexible containers to be continuously inspected on a production line and a high inspection precision to be obtained.

Means for Solving the Problem

That is, the aspect of the invention of claim 1 relates to an inspection method of a container comprising inspecting for seal defects of a container and excess entrainment of air in a container in an inspected object comprised of a flexible container in which a liquid is filled, during which placing the inspected object in an air-tight container, sucking out the air in the air-tight container to reduce the pressure sufficient to make container outer walls of the inspected object expand, measuring an expansion dimension of the container outer walls, and judging quality of the inspected object.

The aspect of the invention of claim 2 provides an inspection method of a container as set forth in claim 1 wherein the inspected object is judged for quality by measuring the expansion dimension of the container outer walls at a predetermined pressure reduction value of the pressure reduction process and comparing it with a predetermined threshold value.

The aspect of the invention of claim 3 provides an inspection method of a container as set forth in claim 1 wherein a peak pressure reduction setting relating to the pressure reduction is atmospheric pressure minus 94 to 100 kPa.

The aspect of the invention of claim 4 provides an inspection method of a container as set forth in claim 1 wherein before reducing the pressure for measuring the expansion dimension of the container, the inspected object is preliminarily reduced in pressure and restored.

The aspect of the invention of claim 5 relates to an inspection system of a container provided with a conveying means for conveying an inspected object comprised of a flexible container in which a liquid is filled, an air-tight container for holding the inspected object to be able to be inserted and taken out by the conveying means, a pressure reducing means for sucking out the air in the air-tight container and reducing the pressure sufficient for making the container outer walls of the inspected object expand, a measuring means for measuring an expansion dimension of the container outer walls in the pressure reduction process, and a processing means for judging quality of the container by the expansion dimension of the container outer walls.

The aspect of the invention of claim 6 provides an inspection system of a container as set forth in claim 5 wherein the measuring means measures the expansion dimension of the container outer walls at a predetermined pressure reduction value of the pressure reduction process, and the processing means compares the measured value with a predetermined threshold value.

The aspect of the invention of claim 7 provides an inspection system of a container as set forth in claim 5 wherein the air-tight container holds a plurality of inspected objects, and the measuring means and processing means function for each of the inspected objects.

The aspect of the invention of claim 8 provides an inspection system of a container as set forth in claim 7 wherein a plurality of the air-tight containers are arrayed and alternately or successively connected to the conveying means, the inspected objects are successively placed in the air-tight containers, and the inspected objects are discharged from inside the air-tight containers to the conveying means.

The aspect of the invention of claim 9 provides an inspection system of a container as set forth in claim 5 wherein the air-tight container houses a single inspected object.

The aspect of the invention of claim 10 provides an inspection system of a container as set forth in claim 9 wherein a plurality of the air-tight containers are arrayed and successively connected to the conveying means, the inspected objects are successively housed in the air-tight containers, and the inspected objects are discharged from inside the air-tight containers to the conveying means.

The aspect of the invention of claim 11 provides an inspection system of a container as set forth in claim 5 which covers an inspected object with little air space or no air space in the container after the container is filled with the liquid and an inspected object with no positive pressure in the container.

### Effect of the Invention

According to the inspection method of a container according to the aspect of the invention of claim 1, the method comprises inspecting for seal defects of a container and excess entrainment of air in a container in an inspected object comprised of a flexible container in which a liquid is filled, during which placing the inspected object in an air-tight container, sucking out the air in the air-tight container to reduce the pressure sufficient to make container outer walls of the inspected object expand, measuring an expansion dimension of the container outer walls, and judging excess entrainment of air of the inspected object and defective and good sealing by the difference. For this reason, the single technique of reducing the pressure sufficiently for causing expansion of the container outer walls of the inspected object enables inspection of excess entrainment of air in a container and inspection of seal defects of a container simultaneously and precisely.

According to the aspect of the invention of claim 2, in claim 1, the inspected object is judged for quality by measuring the expansion dimension of the container outer walls at a predetermined pressure reduction value of the pressure reduction process and comparing it with a predetermined threshold value, so the inspection can be performed precisely and efficiently.

According to the aspect of the invention of claim 3, in claim 1, a peak pressure reduction setting relating to the pressure reduction is made atmospheric pressure minus 94 to 100 kPa, so even inspection of a flexible container provided with a certain degree of rigidity can be performed precisely and efficiently by a high degree of vacuum.

According to the aspect of the invention of claim 4, in claim 1, before reducing the pressure for measuring the expansion dimension of the container, the inspected object is preliminarily reduced in pressure and restored, whereby the state of the liquid filled inside the inspected object shifts to a state quickly and clearly causing the expansion of the container outer walls at the time of reduction of pressure at the measurement and the expansion dimension of the container outer walls can be accurately measured in a short time, so inspection can be conducted at a higher performance and high precision.

The aspect of the invention of claim 5 relates to an invention of an inspection system provided with a conveying means for conveying an inspected object comprised of a flexible container in which a liquid is filled, an air-tight container for holding the inspected object to be able to be inserted and taken out by the conveying means, a pressure reducing means for sucking out the air in the air-tight container and reducing the pressure sufficient for making the container outer walls of the inspected object expand, a measuring means for measuring an expansion dimension of the container outer walls in the pressure reduction process, and a processing means for judging quality of the container by the expansion dimension of the container outer walls, so a system can be provided enabling inspection of excess entrainment of air in a container and inspection of seal defects of a container to be performed simultaneously and precisely by a single system.

According to the aspect of the invention of claim 6, in claim 5, the measuring means measures the expansion dimension of the container outer walls at a predetermined pressure reduction value of the pressure reduction process, and the processing means compares the measured value with a predetermined threshold value, so the container can be precisely and efficiently inspected.

According to the aspect of the invention of claim 7, in claim 5, the air-tight container holds a plurality of inspected objects, and the measuring means and processing means function for each of the inspected objects, so a large number of containers can be simultaneously inspected inside the air-tight container. For this reason, there is the effect that high performance inspection can be performed by a simple system.

According to the aspect of the invention of claim 8, in claim 7, a plurality of the air-tight containers are arrayed and alternately or successively connected to the conveying means, the inspected objects are successively placed in the air-tight containers, and the inspected objects are discharged from inside the air-tight containers to the conveying means, so the inspected objects can be inspected by a high performance.

According to the aspect of the invention of claim 9, in claim 5, the air-tight container houses a single inspected object, so the freedom of design of the inspection system structure is increased for the various types and shapes of inspected containers and a wide range of types of container can be inspected precisely and efficiently.

According to the aspect of the invention of claim 10, in claim 9, a plurality of the air-tight containers are arrayed and successively connected to the conveying means, the inspected objects are successively housed in the air-tight containers, and the inspected objects are discharged from inside the air-tight containers to the conveying means, so the containers can be continuously efficiently inspected.

According to the aspect of the invention of claim 11, in claim 5, the inspection system covers an inspected object with little air space (content of container of air or inert gas) or no air space in the container after the container is filled with the liquid and an inspected object with no positive pressure in the container, so the inspected object can be inspected precisely and efficiently.

Best Mode for Working the Invention

Below, the present invention will be explained in detail in accordance with the embodiments of the attached drawings. FIG. 1 is a schematic explanatory view of the main parts of a system for inspecting a container of the present invention, FIG. 2 is a graph illustrating the relationship between the total value of expansion dimensions of the two sides of the container outer walls in the pressure reduction process and the pressure and elapsed time, FIG. 3 is a graph illustrating the relationship between the total value of expansion dimensions of the two sides of the container outer walls when preliminarily reduced in pressure and restored and the pressure and elapsed time, FIG. 4 is a plan view of main parts of an embodiment of an inspection system utilizing an air-tight container housing a plurality of inspected objects, FIG. 5 is a front view of FIG. 4, FIG. 6 is a plan view showing details of a driving means arranged at the top in FIG. 4, FIG. 7 is a view along the arrow X of FIG. 4, FIG. 8 is a plan view of an embodiment of an inspection system utilizing air-tight containers housing single inspected objects, and FIG. 9 is a basic cross-sectional view along the line Y-Y of FIG. 8.

The inspection method of a container according to the aspect of the invention of claim 1 inspects for seal defects of a container in an inspected object comprised of a paper pack or other flexible container in which a beverage or other liquid is filled and for excess entrainment of air in a container. The inspection method of the present invention places an inspected object in an air-tight container, sucks air out from inside the air-tight container to reduce the pressure sufficiently for causing the container outer walls of the inspected object to expand, and measures an expansion dimension of the container outer walls to judge the container.

The embodiment shown in FIG. 1 covers an inspected object M comprised of a box-shaped paper pack container in which a beverage is filled. The inspected object M is placed in an air-tight container 30 of an inspection system 10. The air-tight container 30 is communicated with a pressure reducing means 40 having a known vacuum pump (not shown) as a component through vacuum piping 35. The air inside the air-tight container 30 is sucked out by the vacuum pump to reduce the pressure to a negative pressure sufficient for the container outer walls K1, K2 of the inspected object M to expand.

The expansion dimensions of the container outer walls K1, K2 of the inspected object M are measured by measuring means 50A, 50B utilizing known displacement sensors etc. which measure the distance to the container outer walls of the inspected object M and transmit the data through cables S1, S2 to a known processing means 60. The processing means 60 calculates the difference in distances in the air-tight container 30 before and after pressure reduction and judges the quality of the inspected object M. Note that in the present embodiment, the expansion dimensions of the outer walls of the two sides of the container can be easily measured, so by calculating the expansion dimensions of the outer walls of the two sides, then adding the expansion dimensions of the two sides of the container to obtain a single container expansion dimension and comparing the amount of change of the expansion dimensions of the two sides of the container, the inspection precision is improved. Reference numeral 36 indicates a pressure measurement system, 51, 52 measurement systems, and S3 a cable.

Note that in the present embodiment, the explanation was given of the example of an inspected object M comprised of a box-shaped paper pack container in which a beverage is filled, but the flexible container may also be made of a plastic, aluminum foil, etc., may be shaped as a cup, pouch, or other bag-shaped container etc. Further, the filled liquid is not limited to a beverage and may also be blood for transfusions etc. In this way, the present invention can be applied to various combinations of materials, container shapes, and filled liquids. Further, in the present embodiment, the total value of the expansion dimensions of the outer walls of the two sides of a paper pack container was used to inspect the inspected object, but for a cup-shaped or bag-shaped container or other such container where only the expansion dimension of one direction of the container outer walls can be easily measured, it is also possible to measure the expansion dimension of one location to inspect the container according to the present invention.

In the inspection of the inspected object M, even an inspected object M comprised of a container in which a liquid is sealed but excessive air is not entrained has solute air in the liquid inside the inspected object M and small amounts of air entering when filling the beverage, so the reduction of pressure causes the container outer walls to expand. However, inspected objects M where air is excessively entrained and ones with seal defects start to expand while the pressure reduction value is still small compared with normal inspected objects, that is, good products. Further, the expansion dimensions of the container outer walls at the same pressure reduction value in the pressure reduction process become larger. The present invention, based on this discovery, reduces the pressure sufficiently for causing expansion of the container outer walls of an inspected object, measures an expansion dimension of the container outer walls, and compares the expansion dimension of the outer walls at a predetermined pressure reduction value with a preset threshold value so as to simultaneously inspect for excess entrainment of air and seal defects.

That is, the container outer walls of good products and inspected objects M with excess entrainment of air and seal defects all expand in the pressure reduction process in the air-tight container 30, but the expansion dimensions differ. Further, for each type of container or filled substance of the inspected object covered, there is a setting of pressure reduction at which the difference of the expansion dimensions will be significant and be discernable (peak pressure reduction setting) and a pressure reduction value (inspection pressure reduction value) suitable for measuring the expansion dimension and comparing it with a threshold value. For this reason, the inspected object covered is tested to find in advance the suitable peak pressure reduction setting of the pressure reduction, inspection pressure reduction value for measuring the expansion dimension, and the threshold value, and these conditions are used for inspection of the inspected object at the time of production.

The graph illustrated in the following FIG. 2 shows the relationship between the total value of the expansion dimensions of the two sides of the container outer walls and the pressure and elapsed time in a pressure reduction process when making the peak pressure reduction setting of the pressure reduction the atmospheric pressure minus 98. Note that the inspected object used here is a 30 mm×40 mm×85 mm paper pack container in which a milk beverage is filled. For an inspected object with excess entrainment of air, 0.2 cc of air was intentionally injected into the inspected object and mixed with the milk beverage, while for an inspected object with seal defects, a paper pack container in which a 0.2 mmφ hole was intentionally made was used.

As illustrated above, the container outer walls start to expand from the start of pressure reduction of the air-tight container, but the expansion is fastest in the order of excess entrainment of air, seal defects, and then good products. This difference in the speeds of expansion of the container outer walls is believed due to the air present inside the container of an inspected object with excess entrainment of air reacting the fastest to the drop in ambient pressure, causing an expansion of volume, and causing expansion of the container outer walls. Further, in an inspected object with seal defects, it is believed that due to the effects of the seal defect part of the container, in this case, the 0.2φ hole, the filled liquid reacted faster than a good product to the drop in ambient pressure and caused separation of the solute air in the liquid, and the separated air expanded and caused the container outer walls to expand, therefore the inspected object expanded faster than a good product. Note that even in the good inspected object, the outer walls of the flexible container are pulled by the ambient negative pressure resulting in the inside of the container becoming a negative pressure, whereby the air in the filled liquid gently separates and causes the container outer walls to expand, but slower than an inspected object with seal defects.

For this reason, in FIG. 2, if setting for example, the atmospheric pressure minus 96 kPa, exhibited by the pressure inside the air-tight container 10 shown by the inspection pressure reduction value Pk, with respect to the peak pressure reduction setting Pt of the pressure reduction constituted by the atmospheric pressure minus 98 kPa, in advance as the pressure for inspection by measurement of the expansion dimension of the inspected object and measuring the expansion dimension of the container outer walls at that time, it is possible to judge the quality of the inspected object as follows: That is, if setting an inspected object M exhibiting an expansion dimension of the container outer walls at the inspection pressure reduction value Pk under the good limit dimension Lr as the threshold for good products, setting an inspected object M exhibiting an expansion dimension over the good limit dimension Lr and under the seal defect dimension Lm as the threshold for seal defects, and setting an inspected object M exhibiting an expansion dimension over the seal defect dimension Lm as the threshold value for excess entrainment of air, inspected objects exhibiting the expansion dimensions L1, L2, and L3 can be identified as being good products and having seal defects and excess entrainment of air.

Further, according to the present invention, when making the peak pressure reduction setting for pressure reduction in the air-tight container the atmospheric pressure minus 94 kPa to 100 kPa as described in claim 3, it is possible to effectively identify good products, seal defects, and excess entrainment of air for paper packs and other flexible containers with relatively high rigidity. That is, at a negative pressure of less than atmospheric pressure minus 94 kPa, a paper pack or other container with relatively high rigidity does not sufficiently expand in a short time, so it was believed that efficient inspection and identification of inspected objects were difficult. Further, a peak pressure reduction setting in a high vacuum of atmospheric pressure minus 100 kPa or more is not required in practice. Considering the performance, cost, etc. of the vacuum pump, while not particularly limited to this, atmospheric pressure minus 94 kPa to 100 kPa in range may be employed as the region of the peak pressure reduction setting for good precision inspection of a large number of inspected objects.

Note that in the above explanation, the expansion dimension of the inspected object M at the designated inspection pressure reduction value Pk was compared with threshold values to identify good products and defective products. However, the pressure drop inside the air-tight container 30 is proportional to the time approximately after the start of pressure reduction, so instead of the designated inspection pressure reduction value Pk, it is also possible to measure the expansion dimension of the inspected object M at the designated elapsed time Tk after the start of pressure reduction and compare this with the predesignated threshold values to inspect an inspected object M.

Note that the data of the pressure inside the air-tight container 30 and expansion dimension of the container outer walls illustrated in FIG. 2 change due to the material and dimensions of the inspected object container, the type of the filled liquid, the size of the air-tight container, the capacity of the vacuum pump, the peak pressure reduction setting at the time of pressure reduction, etc. In this way, if the inspection conditions differ, different curves are obtained in the graph, so the suitable peak pressure reduction setting Pt and inspection pressure reduction value Pk for the inspection conditions and the inspected object and system are selected for inspection of the inspected object. Further, even when identifying the quality of inspected objects by measuring the expansion dimension at one location of the container such as with cup-shaped and bag-shaped containers, a similarly designed test is conducted in advance to determine the preferable inspection conditions for inspection of the inspected object.

Further, according to the present invention, as described in claim 11, when inspecting a container with little air space or a container with no air space and a container with no positive pressure inside as the inspected object, the difference in the amount of change of the expansion dimensions of the two sides of the container accompanying pressure reduction in the air-tight containers 30 is particularly clearly expressed, so it is possible to precisely identify inspected objects of good products, seal defects, and excess entrainment of air.

FIG. 3 is a graph showing the relationship between the total value of the expansion dimensions of the two sides of the container outer walls and the pressure when performing the preliminary pressure reduction and restoration of an inspected object according to the aspect of the invention of claim 4. The pressure in the air-tight container 30 is reduced once to P1, then restored to atmospheric pressure. At this time, the air in the beverage or other filled liquid in the container separates from the filled liquid in advance in the pressure reduction process whereby, at the time of inspection of the inspected object M, the expansion of the container outer walls is accelerated and the differences due to the state of the inspected object appear more clearly. For this reason, compared with when not conducting preliminary pressure reduction, it becomes possible to measure difference in the inspected object in a short time and more clearly identify excess entrainment of air, seal defects, and good products and possible to perform higher precision inspection more efficiently.

That is, compared with the graph in the case of not performing the preliminary pressure reduction shown in FIG. 2, when performing the preliminary pressure reduction of FIG. 3, expansion and enlargement of the outer walls of the inspected object occurs in a short time, the difference in expansion dimensions of the inspected object M at the designated inspection pressure reduction value Pk becomes larger, and excess entrainment of air, seal defects, and good products can be more clearly identified and the inspection precision and inspection ability can be improved.

Next, in an embodiment of an inspection system using air-tight containers holding a plurality of inspected objects M shown in FIG. 4 and FIG. 5, the inspection system 10 is provided with a transport conveyor 20 as a conveying means, two air-tight containers 30A, 30B, a pressure reducing means 40, a measuring means 50, and a not shown processing means 60. The transport conveyor 20 conveys the containers M to the air-tight container 30A or 30B and, after the inspection, conveys the inspected objects M discharged from the air-tight container 30A, 30B downstream. Further, the air-tight containers 30A, 30B stores inspected objects M on the transport conveyor 20 inside them, then are made air-tight as explained in detail later and are connected with the vacuum pump of the pressure reducing means 40 by the vacuum piping 35. Due to this, air inside the air-tight containers 30A, 30B is sucked out to reduce the pressure.

As shown in FIG. 4, in this embodiment, the air-tight containers 30 are two air-tight containers 30A, 30B which move back and forth intermittently over the transport conveyor 20 as shown by the arrow D whereby one air-tight container 30, in the illustration, the air-tight container 30B, stops at a position above the transport conveyor 20. The air-tight container 30B stopping over the transport conveyor 20 opens its exit door 31B and discharges the plurality of inspected objects M inside it on the transport conveyor 20. After this, the air-tight container 30B closes its exit door 31B, opens its inlet door 31A, takes in a plurality of inspected objects M from the transport conveyor 20 and stores them inside, then moves to the inspection position of the air-tight container 30C shown by the broken line. Further, at this time, the other air-tight container 30A moves over the transport conveyor 20 and discharges its inside inspected objects M to the transport conveyor 20 and picks up new inspected objects M inside it.

Note that the step of receiving new inspected objects M from the transport conveyor 20 and storing them inside the air-tight container 30 is performed by closing the exit door 31B, opening the inlet door 31A, and, in that state, using the known means of a container feed system 15 installed at the upstream side of the transport conveyor 20 to count and feed a predetermined number of inspected objects. Further, the air-tight container 30B holding the new inspected objects M moves to the inspection position of the air-tight container 30C shown by the broken line where the inspected objects M undergo predetermined inspection explained in detail later. Further, similarly, the air-tight container 30A holding new inspected objects M at the position of the air-tight container 30B performs inspection at the inspection position of the air-tight container 30A shown by the solid line. That is, the two air-tight containers 30A, 30B alternately move in a direction perpendicular to the advancing direction of the transport conveyor to inspect the inspected objects M at the inspection positions of the two sides of the transport conveyor 20.

In FIG. 5, the air-tight container 30B (30A) is supported on the transport conveyor 20 by the air-tight container movement system 16 and moves as explained in detail later to be alternately connected to the conveying means constituted by the transport conveyor 20. The air-tight container 30B (30A) successively holds a plurality of inspected objects M. Further, the inspected objects M which are finished being inspected are discharged from the air-tight container 30B (30A) to the transport conveyor 20. Further, the air-tight containers 30B and 30A are supported fixed integrally to the movement brackets 19, while the movement brackets 19 are supported slidably with respect to the movement rails 21.

Further, as shown in FIG. 6, the air-tight container movement system 16 is supported by the support bracket 17 and provided over the transport conveyor 20 and air-tight containers 30A, 30B. Note that in the figure, the state is shown where the air-tight containers 30A are moved to positions corresponding to the transport conveyor 20.

As shown in FIG. 7, the movement brackets 19 are fixed to a timing belt 23, are moved by a drive motor 18 through pulleys 22 as shown by the arrow, and move and position the air-tight containers 30A and 30B in the left-right direction of the conveyor 20. The air-tight plates 24 arranged below the inspection positions of the illustrated air-tight containers 30A and 30C are driven by the lift cylinders 25 to move in the up-down direction so as to make the bottoms of the air-tight containers 30A and 30C (30B) air-tight and enable reduction of the pressure inside. Further, the slide plate 26 has the function of enabling the inspected objects M held inside the open bottom air-tight containers 30A, 30B to slide smoothly on its top surface to move to the inspection positions when moving to the left and right.

As explained above, even in a system which houses pluralities of inspected objects M in the air-tight containers 30A, 30B and simultaneously inspects the pluralities of inspected objects M, basically the inspection is performed in the same way as the inspection process explained in FIG. 1. Further, as shown specifically in FIG. 4 and FIG. 7, a plurality of measuring means 50A, 50B are provided corresponding to the inspected objects M, individually measure the distances to the container outer walls, and transmit the data to the processing means 60 which then individually processes the data, calculates the total values of the expansion dimensions of the two sides of the container outer walls of the inspected objects, individually compares them with the threshold values, and thereby inspects the inspected objects.

Further, the above-mentioned results of judgment of the inspected objects are deemed as individual data linked with the positions of the inspected objects M in the air-tight container 30, that is, their order in the arrays, and are stored in the processing means 60 as individual data corresponding to the inspected objects. Further, the inspected objects discharged to the transport conveyor 20 are conveyed downstream during which a not shown container pushout system or other known container ejection system is used to eject objects from the conveyor at different locations according to whether they exhibit excess entrainment of air or seal defects. Note that it is also possible to eject the defective products at the same locations on the conveyor or, instead of ejecting the defective products from the transport conveyor 20, issue a signal indicating the occurrence of a defective container and perform other post-processing. This may be freely selected in accordance with the characteristics of the production line inspecting the inspected objects M.

Note that when the inspected object M is a cup-shaped or a bag-shaped container and the expansion dimension is measured at a single point on the container outer walls such as the top surface of the inspected object M, calculation of the total value of the expansion dimensions at the two sides explained above becomes unnecessary. The expansion dimension at a single point of the outer walls of the inspected object M is measured for inspection of the inspected object M, the inspected object M is discharged to the transport conveyor, then the object is subjected to the predetermined processing.

Note that as an embodiment where a plurality of air-tight containers holding pluralities of inspected objects M, the case of two air-tight containers 30A, 30B moving back and forth was explained, but it is also possible to employ a rotary type configuration in which three or more air-tight containers 30 rotate above a vertical direction or horizontal direction axis. The present invention is not limited to the above embodiment. With the scope of the gist of the present invention, it is possible to utilize other configurations of container inspection systems.

Below, in FIG. 8, an embodiment of the inspection system 10 in the case of utilizing air-tight containers holding single inspected objects M and using cylindrically shaped cups as the inspected objects M will be explained. As illustrated, the inspection system 10 is a rotary type which rotates as shown by the arrow. The inspected objects M are conveyed on a transport conveyor 20 and inched forward by an infield screw 11 through a feed star wheel 12 to be fed onto the rotary disk 13 to be inspected. Further, the inspected objects M after the inspection are discharged through an exhaust star wheel 14 to the transport conveyor 20.

The rotary disk 13 is provided with air-tight containers 30 moving in the up-down direction, explained in detail later, corresponding to feed positions of the inspected objects M. The air-tight containers 30 rise up at the positions of the feed star wheel 12 and exhaust star wheel 14 so that without interference with the air-tight containers 30 the inspected objects M may be fed onto the rotary disk 13 and the inspected objects M may be discharged onto the transport conveyor 20.

As shown in FIG. 9, each air-tight container 30 moves up and down by a lift cylinder 37 via an up-down movement bracket 39 to enable feeding of an inspected object M to the air-tight container 30 and its discharge. Further, air inside the air-tight container 30 is sucked out for reduction of pressure through vacuum piping 35 and rotary boards 38A, 38B and flexible vacuum piping 35A by a not shown vacuum pump. Further, the pressure inside the air-tight container 30 and the expansion dimension of the top surface of the inspected object M measured by the measuring means 50 are taken out to the outside through cables S1, S3 and a not shown rotary joint and processed. Reference numerals 36A and S1A indicate cables.

Note that in the embodiments in which a plurality of the air-tight containers are arrayed, the explanation was given of the case of utilizing cylindrically shaped air-tight containers 30 for cylindrically shaped inspected objects M, but the present invention is not limited to these embodiments and may also use box-shaped air-tight containers 30 for box-shaped inspected objects M such as paper packs and blood transfusion bags. Within the scope of the gist of the present invention, it is possible to utilize other configurations of container inspection systems.

### BRIEF DESCRIPTION OF THE DRAWINGS

FIG. 1 is a schematic explanatory view of the main parts of a system for inspecting a container of the present invention.

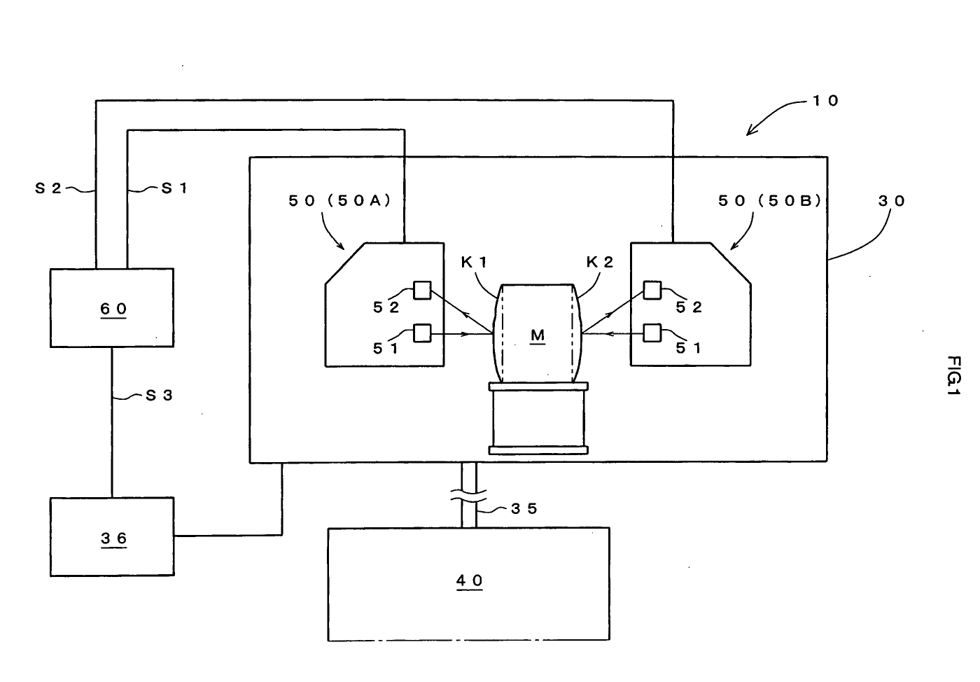

FIG. 2 is a graph illustrating the relationship between the total value of expansion dimensions of the two sides of the container outer walls in the pressure reduction process and the pressure and elapsed time.

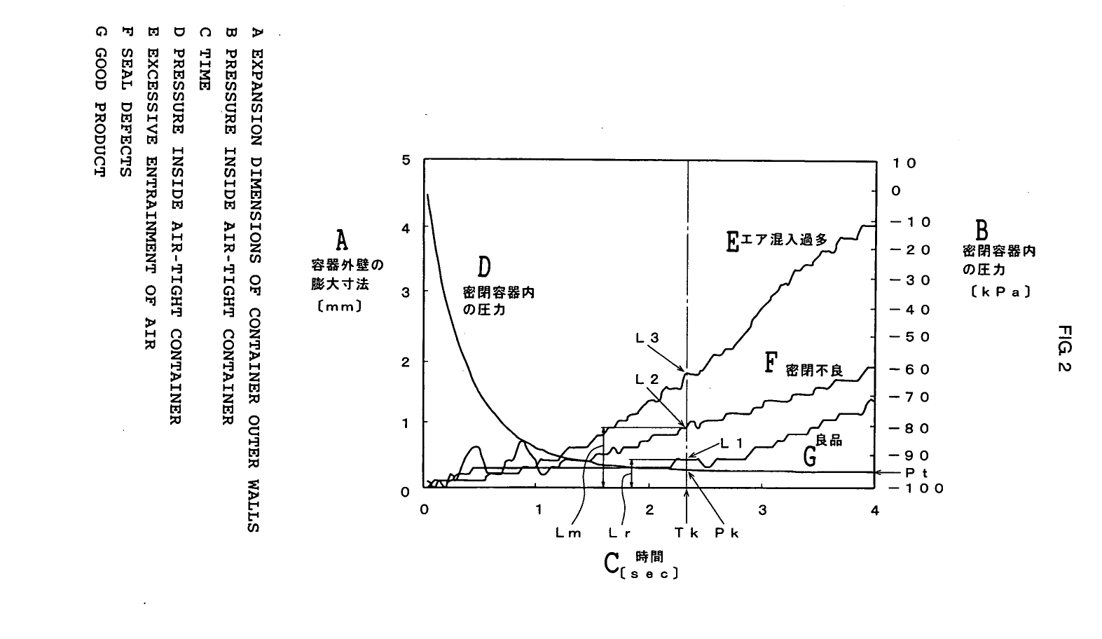

FIG. 3 is a graph illustrating the relationship between the total value of expansion dimensions of the two sides of the container outer walls when preliminarily reduced in pressure and restored and the pressure and elapsed time.

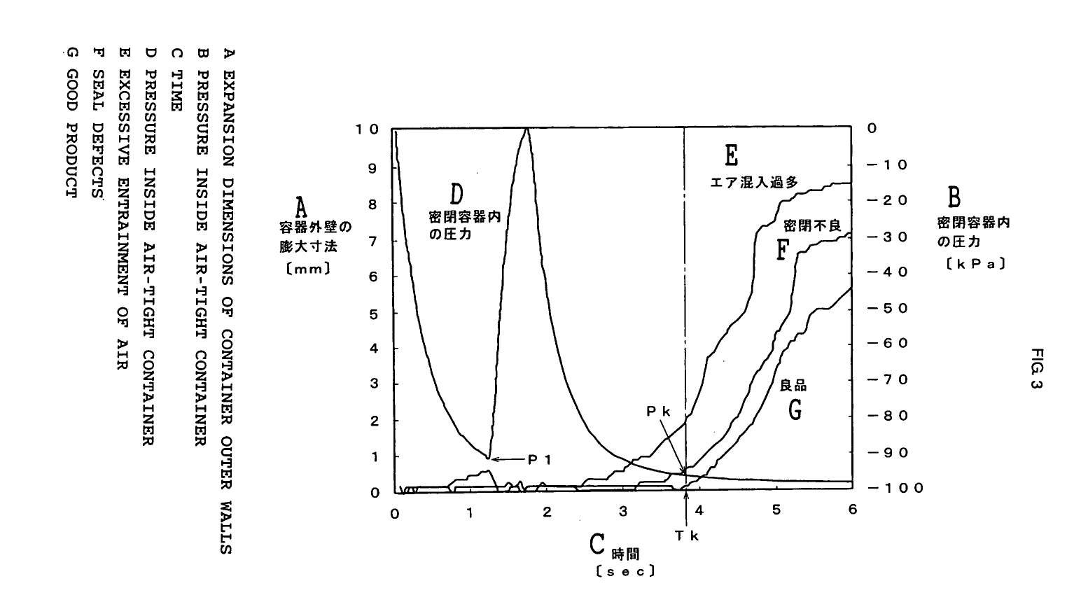

FIG. 4 is a plan view of main parts of an embodiment of an inspection system utilizing an air-tight container housing a plurality of inspected objects.

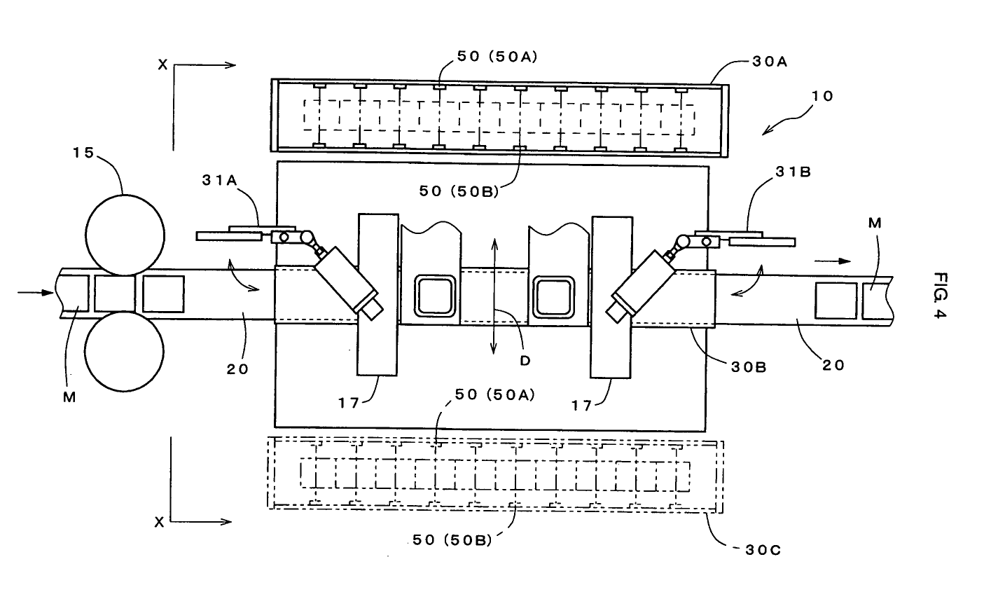

FIG. 5 is a front view of FIG. 4.

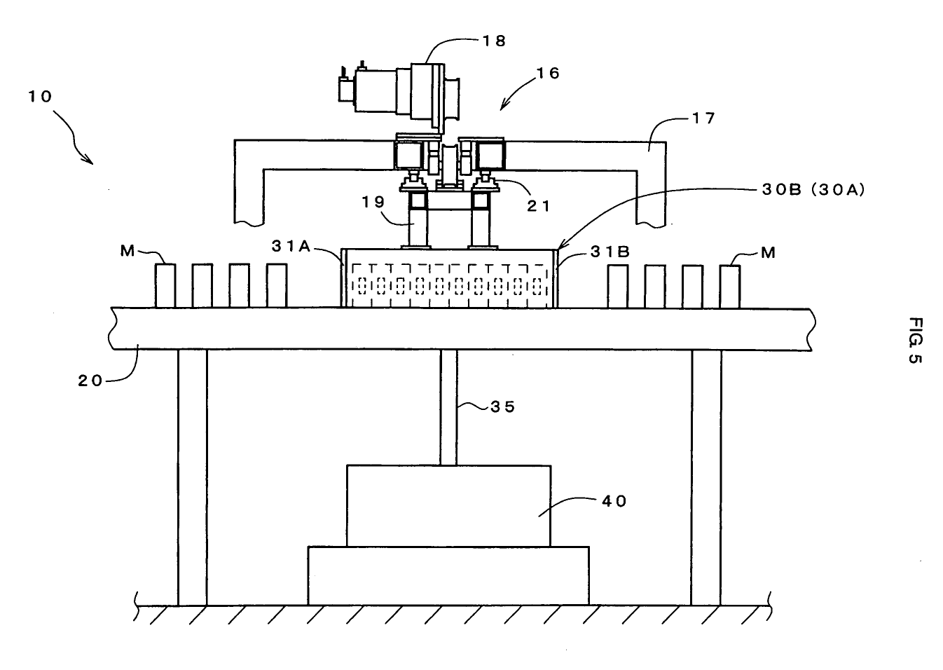

FIG. 6 is a plan view showing details of a driving means arranged at the top in FIG. 4.

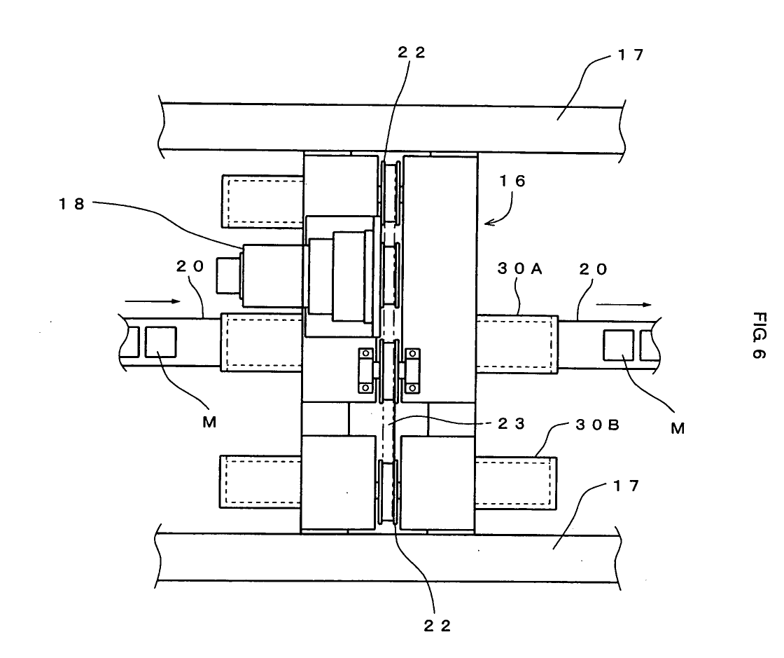

FIG. 7 is a view along the arrow X of FIG. 4.

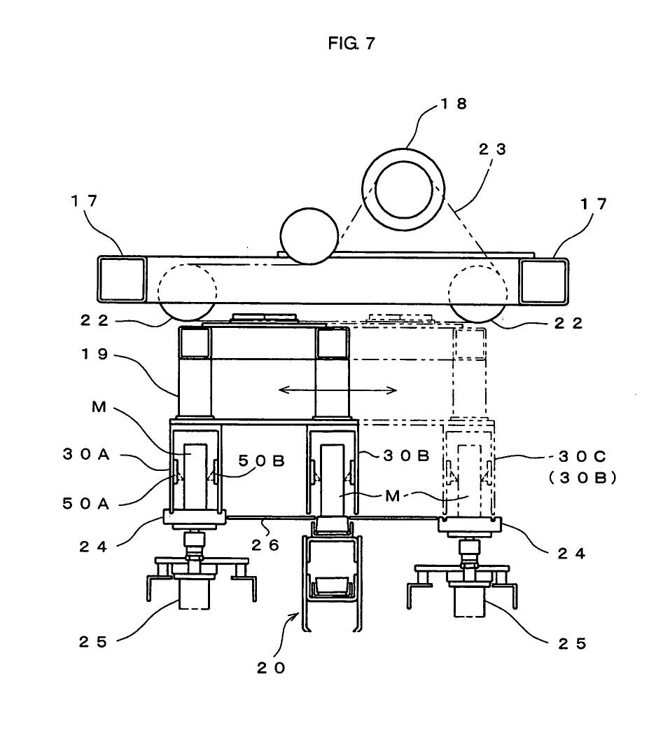

FIG. 8 is a plan view of an embodiment of an inspection system utilizing air-tight containers housing single inspected objects.

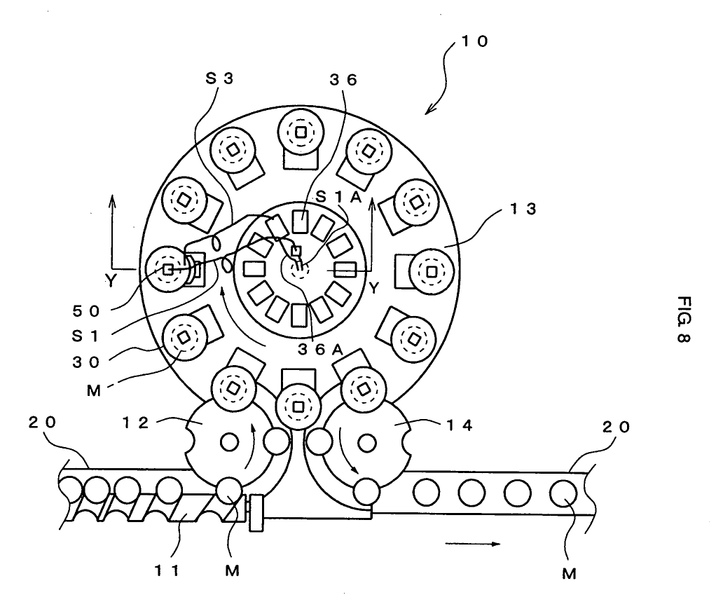

FIG. 9 is a basic cross-sectional view along the line Y-Y of FIG. 8.

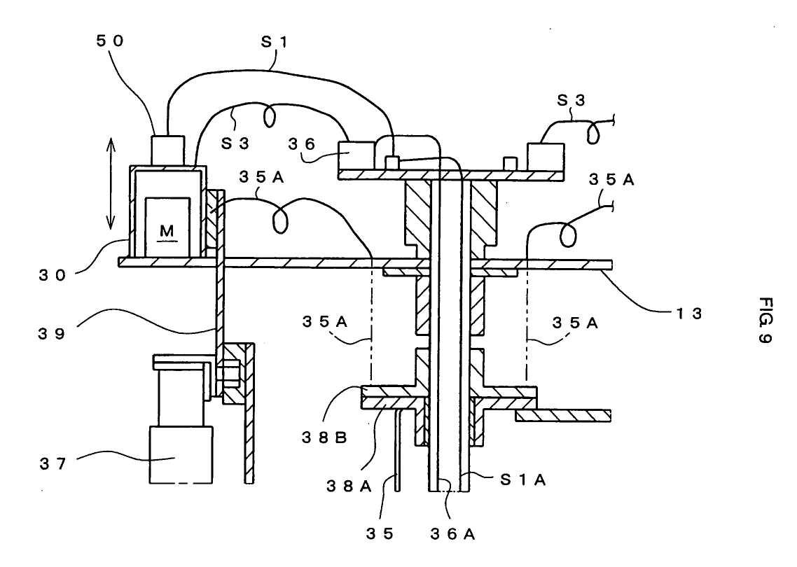

### DESCRIPTION OF NOTATIONS

10 inspection system

11 infield screw

12 feed star wheel

13 rotary disk

14 exhaust star wheel

16 air-tight container movement system

17 support bracket

19 movement bracket

20 transport conveyor (conveying means)

21 movement rail

22 pulley

23 timing belt

24 air-tight plate

25 lift cylinder

26 slide plate

30, 30A to 30C air-tight container

31A inlet door

31B exit door

35 vacuum piping

36 pressure measurement system

37 lift cylinder

38A, 38B rotary board

39 up-down movement bracket

40 pressure reducing means

50, 50A, 50B measuring means

51, 52 measurement system

60 processing means

K1 container outer walls

K2 container outer walls

L1 to L3 expansion dimensions

Lm seal defect dimensions

Lr good limit dimensions

M inspected object

Pk inspection pressure reduction value

Pt peak pressure reduction setting

S1 to S3 cable

Tk elapsed time

1. An inspection method of a container comprising inspecting for seal defects of a container and excess entrainment of air in a container in an inspected object comprised of a flexible container in which a liquid is filled, during which placing said inspected object in an air-tight container, sucking out the air in said air-tight container to reduce the pressure sufficient to make container outer walls of said inspected object expand, measuring an expansion dimension of said container outer walls, and judging quality of the inspected object.

2. An inspection method of a container as set forth in claim 1 wherein said inspected object is judged for quality by measuring the expansion dimension of said container outer walls at a predetermined pressure reduction value of said pressure reduction process and comparing it with a predetermined threshold value.

3. An inspection method of a container as set forth in claim 1 wherein a peak pressure reduction setting relating to said pressure reduction is atmospheric pressure minus 94 to 100 kPa.

4. An inspection method of a container as set forth in claim 1 wherein before reducing the pressure for measuring the expansion dimension of said container, said inspected object is preliminarily reduced in pressure and restored.

5. An inspection system of a container provided with a conveying means for conveying an inspected object comprised of a flexible container in which a liquid is filled, an air-tight container for holding said inspected object to be able to be inserted and taken out by said conveying means, a pressure reducing means for sucking out the air in said air-tight container and reducing the pressure sufficient for making the container outer walls of said inspected object expand, a measuring means for measuring an expansion dimension of said container outer walls in said pressure reduction process, and a processing means for judging quality of the container by the expansion dimension of said container outer walls.

6. An inspection system of a container as set forth in claim 5 wherein said measuring means measures the expansion dimension of said container outer walls at a predetermined pressure reduction value of said pressure reduction process, and said processing means compares said measured value with a predetermined threshold value.

7. An inspection system of a container as set forth in claim 5 wherein said air-tight container holds a plurality of inspected objects, and said measuring means and processing means function for each of the inspected objects.

8. An inspection system of a container as set forth in claim 7 wherein a plurality of said air-tight containers are arrayed and alternately or successively connected to said conveying means, said inspected objects are successively placed in said air-tight containers, and said inspected objects are discharged from inside said-air-tight containers to said conveying means.

9. An inspection system of a container as set forth in claim 5 wherein said air-tight container houses a single inspected object.

10. An inspection system of a container as set forth in claim 9 wherein a plurality of said air-tight containers are arrayed and successively connected to said conveying means, said inspected objects are successively housed in said air-tight containers, and said inspected objects are discharged from inside said air-tight containers to said conveying means.

11. An inspection system of a container as set forth in claim 5 which covers an inspected object with little air space or no air space in the container after the container is filled with the liquid and an inspected object with no positive pressure in the container.
